(19) United States
(12) Patent Application Publication
(10) Pub. No.: US 2002/0003610 A1
(43) Pub. Date: Jan. 10, 2002

(54) Projection type display system using a polarizing beam splitter

(75) Inventors: Jong Myoung Park, Suwon-Shi (KR); Kwang Joe Jeon, Suwon-Shi (KR)

Correspondence Address: DARBY & DARBY P.C., 805 Third Avenue, New York, NY, 10022, US

(73) Assignee: SAMSUNG ELECTRO-MECHANICS CO., LTD., SUWON-SHI (KR)

(21) Appl. No.: 09/798,535

(22) Filed: Mar. 2, 2001

(30) Foreign Application Priority Data
Jun. 26, 2000 (KR) 2000-35226
Jan. 11, 2001 (KR) 2001-1524

(51) Int. Cl. G02F 1/1335; G02B 5/30; G02B 27/28

(52) U.S. Cl. 353/31; 349/9; 359/498; 359/502

(57) ABSTRACT

A projection system in which the structure of a polarizing beam splitter is improved to eliminate the deterioration of a polarizing plate occurring in incidence of polarized light using the polarizing plate so that the degradation of the projection system can be prevented and life time thereof can be prolonged. The projection system comprises a lamp for irradiating non-polarized white light; first polarizing beam splitter for transmitting unnecessary P wave from the white light irradiated from the lamp and reflecting the S wave along first direction perpendicular to the direction of the P wave; second polarizing beam splitter for reflecting the S wave reflected from the first polarizing beam splitter along second direction perpendicular to the first incident direction and transmitting the P wave; a color separation/composition system for separating and projecting each of R, G and B components from the S wave light reflected from the second polarizing beam splitter, and for composing the P wave light introduced along the projection direction to be projected to the second polarizing beam splitter side; LCDs for providing an image corresponding to each of the R, G and B components of the light separated and projected from the color separation/composition system; and a projective system for projecting the P wave light transmitted from the second polarizing beam splitter to a screen to form a picture image after each of the R, G and B components reflected from the LCDs and including each of the images is composed in the color separation/composition system. Degradation of the polarizing plate during illuminating polarized light can be eliminated by using the polarizing beam splitter so that performance deterioration of the projection system can be prevented and life time of the product can be prolonged.

### BACKGROUND OF THE INVENTION

1. Field of the Invention

The present invention relates to a projection system using a polarizing beam splitter, and more particularly, to a projection system in which the structure of a polarizing beam splitter is improved to eliminate deterioration of a polarizing plate occurring in incidence of polarized light using the polarizing plate so that the degradation of the projection system can be prevented and life time thereof can be prolonged.

2. Description of the Prior Art

As recently displays are getting large sized, development of data projector, projection TV, projection monitor, etc. which use projection technology is accelerated. Lately, studies are being carried out about a reflective liquid crystal panel where a reflective electrode is installed in each picture cell to enhance the opening ratio of picture cells, which are being applied to a projective liquid crystal projector. This reflective liquid crystal panel can enhance the opening ratio compared to a conventional transmission liquid crystal panel and accordingly can realize a compact and high efficient projector.

In general, a projection system can be mainly comprised of an illumination system, a color separation/composition unit and a projective system. In the projection system, when a reflective LCD is used as an imager, illuminating polarized light to the imager is required for a path change between the illumination system and the projective system and thus a polarizing element is necessary for the illumination system.

Here, when the polarizing plate is used to generate polarized light, the polarizing plate absorbs at least 50% quantity of illuminated light according to the properties and thus the absorbed light is converted into heat to degrade the polarizing plate.

FIG. 1 is a drawing for illustrating functions of a general polarizing plate.

As shown in FIG. 1, non-polarized light 1 is incident upon a polarizing plate 2, ideally 50% of light quantity is transmitted by the polarizing plate as polarized light 3 in the polarizing direction and the rest 50% of light quantity is absorbed by the polarizing plate 2.

In the prior art, such a polarizing plate is used to compose a projection system as shown in FIG. 2.

FIG. 2 is a structural view for illustrating an example of a reflective projector apparatus of the prior art. As shown in FIG. 2, the reflective projector apparatus is mainly comprised of a lower side, a light source 11, a polarizing plate 12, a polarizing beam splitter(PBS) 13, a dichroic prism 14, reflective liquid crystal panels 15R, 15G and 15B (herein, each of R, G and B indicates each of red, green and blue colors, respectively) and a projective lens 16.

In this configuration, P wave as 50% of the non-polarized light from the light source 11 is absorbed in the polarizing plate 12 and S wave as 50% of the non-polarized light is transmitted due to the properties described about the appended FIG. 1. Then, upon being transmitted by the polarizing plate 12, all the S wave is reflected from the polarizing beam splitter 13 toward the dichroic prism 14 according to the properties thereof.

Upon being incident upon the dichroic prism 14, the light is separated into red(R), green(G) and blue(B) components. Each component is reflected from each of the reflective liquid crystal panels 15R, 15G and 15B corresponding to each color and then passes along same optical path to be incident upon the polarizing beam splitter 13 again.

Here, since the light, which was image modulated by each of the reflective liquid panels 15R, 15G and 15B, is irradiated with the polarizing direction being rotated 90° in the on-state range of the liquid crystal or the incident S wave is converted into the P wave as being reflected, the irradiated light corresponding to the on-state range is transmitted by the polarizing beam splitter 13 and then is projected to a screen (not shown) from the projective lens 16 to form a picture image.

The reflective projector having the structure as shown in FIG. 2 is generally referred to as 3-plate type projector, in which the polarized beam splitter 13 is required for allowing the illuminated light to proceed toward the projective lens 16 when each reflective liquid crystal panel 15R, 15G and 15B is used, and a polarized illumination light is required when the polarizing beam splitter 13 is used.

As a result, the illumination system requires the polarizing element. If the polarizing plate 12 is used as the polarizing element, the P wave can be transmitted at most 50% according to the properties of the polarizing plate 12. Therefore, there is a problem that the light which is not transmitted at least 50% is absorbed by the polarizing plate 12 and converted to heat, which degrades the polarizing plate 12 to deteriorate the overall performance and shorten life time of the projection system.

### SUMMARY OF THE INVENTION

The present invention is proposed to solve the foregoing problems of the prior art and it is therefore an object of the invention to provide a projection system using a polarizing beam splitter in which the polarizing beam splitter replaces a conventional polarizing plate used as means for obtaining polarized illumination light to eliminate the degradation due to non-transmitted light of about 50% by the polarizing plate, thereby preventing performance deterioration and prolong life time of the projection system.

According to an embodiment of the invention to obtain the foregoing object, it is provided a projection system using polarizing beam splitters, the system comprising: a lamp for irradiating non-polarized white light; first polarizing beam splitter for transmitting unnecessary P wave from the white light irradiated from the lamp and reflecting the S wave along first direction perpendicular to the direction of the P wave; second polarizing beam splitter for reflecting the S wave reflected from the first polarizing beam splitter along second direction perpendicular to the first incident direction and transmitting the P wave; a color separation/composition system for separating and projecting each of R, G and B components from the S wave light reflected from the second polarizing beam splitter, and for composing the P wave light introduced along the projection direction to be projected to the second polarizing beam splitter side; LCDs for providing an image corresponding to each of the R, G and B components of the light separated and projected from the color separation/composition system; and a projective system for projecting the P wave light transmitted from the second polarizing beam splitter to a screen to form a picture image after each of the R, G and B components reflected from the LCDs and including each of the images is composed in the color separation/composition system.

The projection system using polarizing beam splitters further comprises third polarizing beam splitter arranged on the light course proceeding from the first polarizing beam splitter to the second polarizing beam splitter for raising the polarity of the illumination lowered by the P wave included in the light reflected from the polarizing beam splitter and functioning as a cleanup polarizing beam splitter.

Here, the cleanup polarizing beam splitter uses a 3-piece polarizing beam splitter to reduce the size of the projection system.

Also, the color separation/composition system uses an X-prism or a Philips prism.

According to another embodiment of the invention to obtain the foregoing object, it is provided a projection system using polarizing beam splitters, the system comprising: a lamp for irradiating non-polarized white light; a polarizing beam splitter for transmitting unnecessary P wave from the white light irradiated from the lamp and reflecting the S wave along first direction perpendicular to the direction of the P wave; a color separation/composition system for separating and projecting each of R, G and B components from the S wave light reflected from the second polarizing beam splitter, and for composing the P wave light introduced along the projection direction to be projected to the second polarizing beam splitter side; LCDs for providing an image corresponding to each of the R, G and B components of the light separated and projected from the color separation/composition system; a projective system for projecting the P wave light transmitted from the second polarizing beam splitter to a screen to form a picture image after each of the R, G and B components reflected from the LCDs and including each of the images is composed in the color separation/composition system.

The projection system using polarizing beam splitters further comprises third polarizing beam splitter arranged on the light course proceeding from the first polarizing beam splitter to the second polarizing beam splitter for raising the polarity of the illumination lowered by the P wave included in the light reflected from the polarizing beam splitter and functioning as a cleanup polarizing beam splitter.

Here, the cleanup polarizing beam splitter uses a 3-piece polarizing beam splitter to reduce the size of the projection system.

Also, the color separation/composition system uses a color corner or a color quad.

According to other embodiment of the invention to obtain the foregoing object, it is provided a projection system using polarizing beam splitters, the system comprising: a lamp for irradiating non-polarized white light; first polarizing beam splitter for reflecting unnecessary S wave from the white light irradiated from the lamp and transmitting the P wave; second polarizing beam splitter for transmitting the P wave reflected from the first polarized beam splitter and reflecting the S wave incident along the transmission direction of the P wave; a color separation/composition system for separating and projecting each of R, G and B components from the P wave light reflected from the second polarizing beam splitter, and for composing the S wave light introduced along the projection direction to be projected to the second polarizing beam splitter side; LCDs for providing an image corresponding to each of the R, G and B components of the light separated and projected from the color separation/composition system; and a projective system for projecting the S wave light reflected from the second polarizing beam splitter to a screen to form a picture image, after each of the R, G and B components reflected from the LCDs and including each of the images is composed in the color separation/composition system.

Here, the color separation/composition system uses an X-prism or a Philips prism.

According to further embodiment of the invention to obtain the foregoing object, it is provided a projection system using polarizing beam splitters, the system comprising: a lamp for irradiating non-polarized white light; a polarizing beam splitter for reflecting unnecessary S wave from the white light irradiated from the lamp and transmitting the P wave; a color separation/composition system for separating and projecting each of R, G and B components from the P wave light reflected from the second polarizing beam splitter, and for composing the S wave light introduced along the projection direction to be projected to the second polarizing beam splitter side; LCDs for providing an image corresponding to each of the R, G and B components of the light separated and projected from the color separation/composition system; and a projective system for projecting the S wave light reflected from the second polarizing beam splitter to a screen to form a picture image, after each of the R, G and B components reflected from the LCDs and including each of the images is composed in the color separation/composition system.

Here, the color separation/composition system uses a color corner or a color quad.

### BRIEF DESCRIPTION OF THE DRAWINGS

FIG. 1 is a drawing for illustrating functions of a general polarizing plate;

FIG. 2 is a drawing for illustrating the structure of a reflective 3-plate type LCD projection system.

FIG. 3 is a drawing for illustrating the structure of a projection system using a polarizing beam splitter according to the invention;

FIG. 4 illustrates a 3-polarizing beam splitter according to the invention;

FIG. 5 illustrates where the 3-polarizing beam splitter is applied to the projection system shown in FIG. 3;

FIG. 6 is a structural view for illustrating the projection system shown in FIG. 3 where the P wave is used as an illumination;

FIG. 7 is a structural view for illustrating a projection system using a color corner as a color separation/composition system;

FIG. 8 illustrates where the 3-polarizing beam splitter is applied to the projection system shown in FIG. 7;

FIG. 9 is a structural view for illustrating the projection system shown in FIG. 7 where the P wave is used as an illumination;

FIG. 10 is a structural view for illustrating a projection system using a color quad as a color separation/composition system;

FIG. 11 illustrates where the 3-polarizing beam splitter is applied to the projection system shown in FIG. 10.

FIG. 12 is a structural view for illustrating the projection system shown in FIG. 10 where the P wave is used as an illumination.

FIG. 13 is a structural view for illustrating a projection system using a Phillips prism as a color separation/composition system;

FIG. 14 illustrates where the 3-polarizing beam splitter is applied to the projection system shown in FIG. 13; and

FIG. 15 is a structural view for illustrating the projection system shown in FIG. 13 where the P wave is used as an illumination.

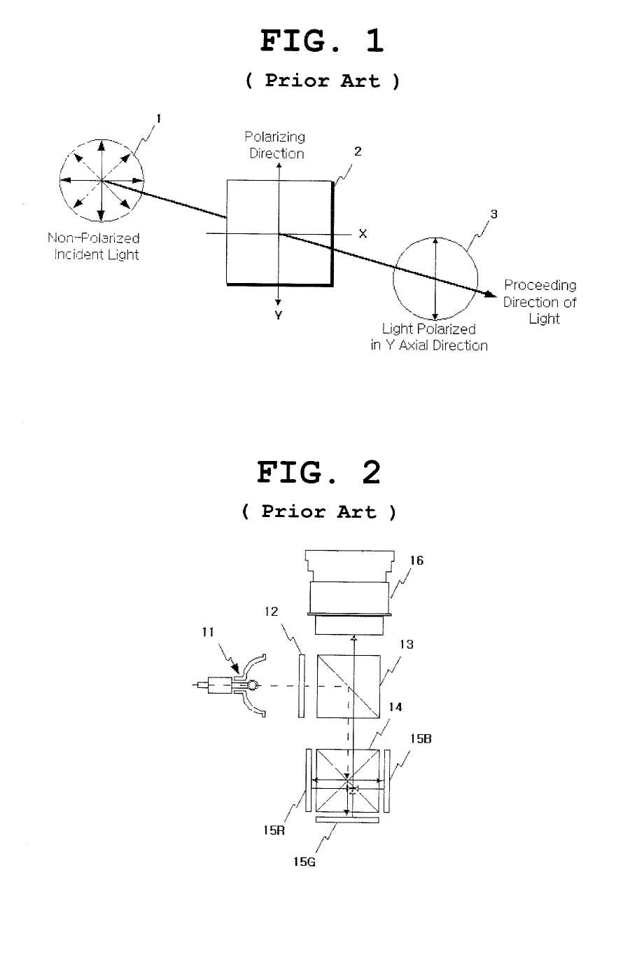

### DETAILED DESCRIPTION

The foregoing object and various advantages of the present invention will be more apparent to those skilled in the art from the following description of the preferred embodiments of the invention given in reference to the appended drawing.

Briefly describing the technical spirit applied to the invention, a polarizing beam splitter replaces a polarizing plate of the prior art which is used as means for obtaining polarized illumination light in a projection engine as a core part of a projection system in order to prevent the degradation caused by the polarizing plate absorbing about 50% of the polarized light which is not transmitted. Here, the polarizing beam splitter, when filtering the light of a specific polarizing direction, transmits the light along the direction angled 90° in respect to the polarizing direction without absorbing the unnecessary light of the polarizing direction so that the heat generation due to the light absorption can be eliminated and thus the degradation can be avoided.

Hereinafter, a preferred embodiment of the invention will be described in reference to the appended drawings.

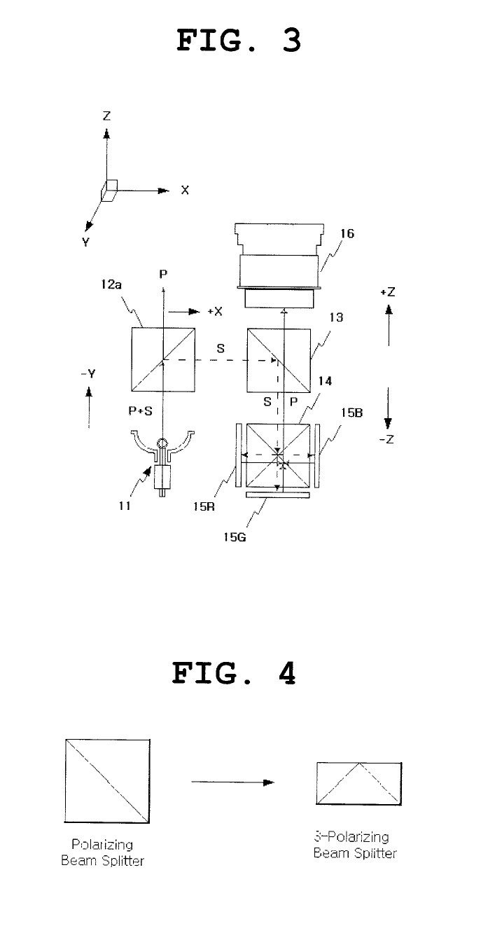

FIG. 3 is a drawing for illustrating the structure of a projection system using a polarizing beam splitter according to the invention.

Referring to FIG. 3, the reference numeral 11 designates a lamp for irradiating non-polarized white light, 12a designates first polarizing beam splitter for transmitting the P wave from the irradiated light and reflecting the S wave from the same so that the proceeding direction can be changed, 13 designates second polarizing beam splitter for changing direction between an illumination system and a projective system, 14 designates a dichroic prism for functioning as a color separation/composition system, each of 15R, 15G and 15B designates a reflective LCD, and 16 designates a projective lens.

The structure according to the invention as shown in FIG. 3 is indicated as a 3-dimensional coordinate system. As shown in FIG. 3, if the light irradiated from the lamp 11 is assumed to proceed along the negative Y axial direction toward the first polarizing beam splitter 12a, the light reflected from the first polarizing beam splitter 12a can be defined to proceed along the positive X axial direction toward the second polarizing beam splitter 13.

Also, as the light reflected from the first polarized beam splitter 12a is defined to proceed along the positive X axial direction toward the second polarizing beam splitter 13 side, the light reflected from the second polarizing beam splitter 13 can be defined to proceed along the negative Z axial direction toward the dichroic prism 14 and the light which is color composed in the dichroic prism 14 side can be defined to proceed to the positive Z axial direction to the projective lens 16 through the second polarizing beam splitter 13.

The operation of the invention having the foregoing structure can be described as follows:

First, the S wave which is 50% of the non-polarized light from the lamp 11 is reflected from the first polarizing beam splitter 12a to proceed along the direction to the second polarizing beam splitter 13 for changing the direction of the illumination system and the projective system, and the P wave which is 50% of the non-polarized light is transmitted by the first polarizing beam splitter 12a to be irradiated from the projection system.

The second polarizing beam splitter 13 is arranged in the 90° rotated direction of the first polarizing beam splitter 12a so that the reflected S wave enters and all the entered S wave is reflected due to the properties of the second polarizing beam splitter 13 to proceed toward the dichroic prism 14.

The light which is incident upon the prism 14 is separated into red, green and blue rays, and each of the separated rays is reflected from each of the reflective liquid crystal panels 15R, 15G and 15B and passes along the same optical path to be incident upon the second polarizing beam splitter(PBS) 13 again.

Here, since the light, which is image modulated by each of the reflective liquid panels 15R, 15G and 15B, is irradiated with the polarizing direction being rotated 90° in the on-state range of the liquid crystal or the incident S wave is converted into the P wave as being reflected, the irradiated light corresponding to the on-state range is transmitted by the polarizing beam splitter(PBS) 13 and then is projected to the screen (not shown) from the projective lens 16 to generate an image.

In this case of the invention, the polarized illumination light is generated by using the first polarizing beam splitter 12a unlikely as polarized illumination light is generated by using the polarizing panel of the prior art. Therefore, the P wave which is unnecessary to the projection system is not absorbed by the first polarizing beam splitter 12a to be irradiated from the projection system so that the polarizing beam splitter as a polarizing element may not be degraded due to the heat.

Here, practically all of the illumination light of the projection system is not incident upon a polarizing coated surface of the first polarizing beam splitter 12a with the angle of 45° about the same and some of the illumination light is incident with the angle other than 45°. Therefore, the first polarizing splitter 12a does not reflect and transmit the light with the S wave and the P wave of 50% so that the reflected light may include the P wave.

In order to raise the polarity of the illumination which is lowered by the reflected P wave like this, an additional polarizing beam splitter can be arranged between the first polarizing splitter 12a and the second polarizing beam splitter 13. The additional polarizing beam splitter functions as a cleanup polarizing panel.

The cleanup polarizing beam splitter transmits most of the S wave from the first polarizing beam splitter 12a and reflects some P wave included thereto to be emitted from the projection system. Therefore, the ratio of the S wave to the P wave incident upon the second polarizing beam splitter 13 is raised and thus the polarity of the illumination light is raised.

Also, in order to reduce the size of the projection system, the cleanup polarizing splitter can have the shape of a 3-polarizing beam splitter(3-PBS) as shown in FIG. 4. The 3-polarizing beam splitter performs the same function as a general polarizing beam splitter while halving the size.

While it has been described about the specific embodiment of the invention, it will be apparent those skilled in the art that various modification and changes can be made without departing from the spirit and scope of the invention defined by the appended claims.

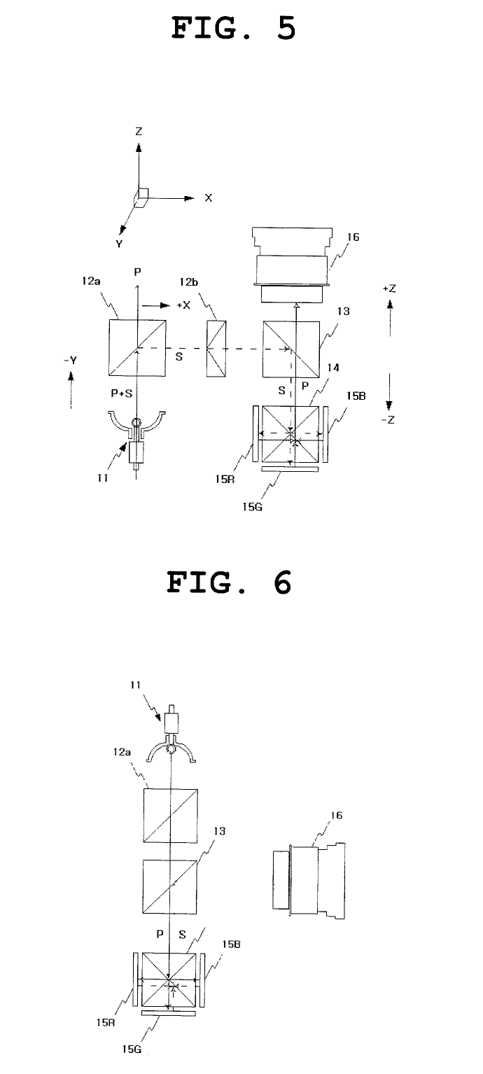

For example, the polarizing illumination system can have various structures as shown in FIG. 5 and FIG. 6.

FIG. 5 illustrates where the 3-polarizing beam splitter is applied to the projection system shown in FIG. 3, in which the 3-polarizing beam splitter 12b is provided between the first polarizing splitter 12a and the second polarizing beam splitter 13 so that the volume of the projection system can be reduced in relation to generally comprising the polarizing beam splitter.

Also, FIG. 6 is a structural view for illustrating the projection system shown in FIG. 3 where the P wave is used as the polarizing light instead of the S wave, in which the S wave is not substantially included in the transmitted P wave according to the properties of the polarizing beam splitter so that the quality enhancement can be made through a simpler structure.

Here, the polarizing state of the light reflected from each of the reflective liquid crystal panels 15R, 15G and 15B is the S wave since the incident light is the polarization of the P wave and thus the polarizing state of the light reflected from the liquid panel is contrary to the cases in FIG. 3 or FIG. 5.

In the foregoing embodiment, the color separation/composition system uses an element called “X-prism”. The color separation/composition system can use “color corner”, “color quad” or “Philips prism” for configuration besides the X-prism.

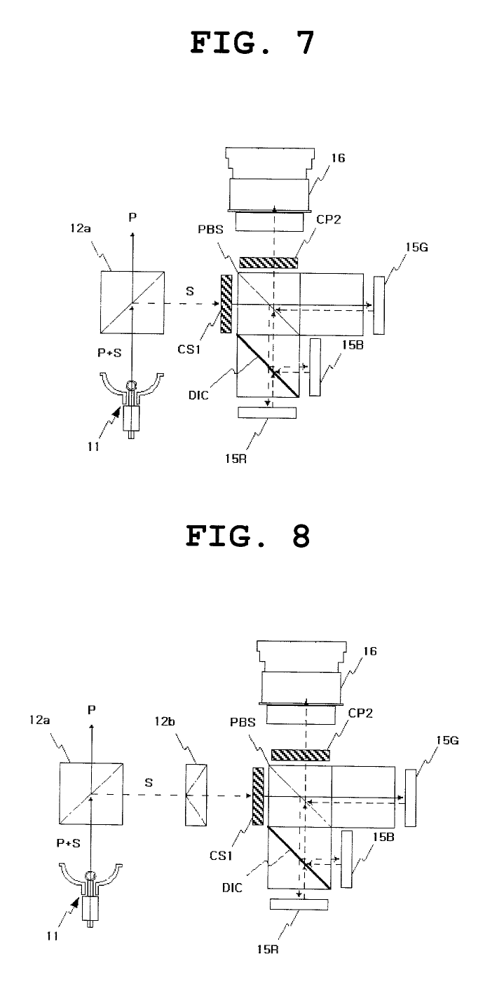

Therefore, the invention also can be used in all projection system using the polarization. Embodiments thereof will be described briefly in reference to FIG. 7 to FIG. 15.

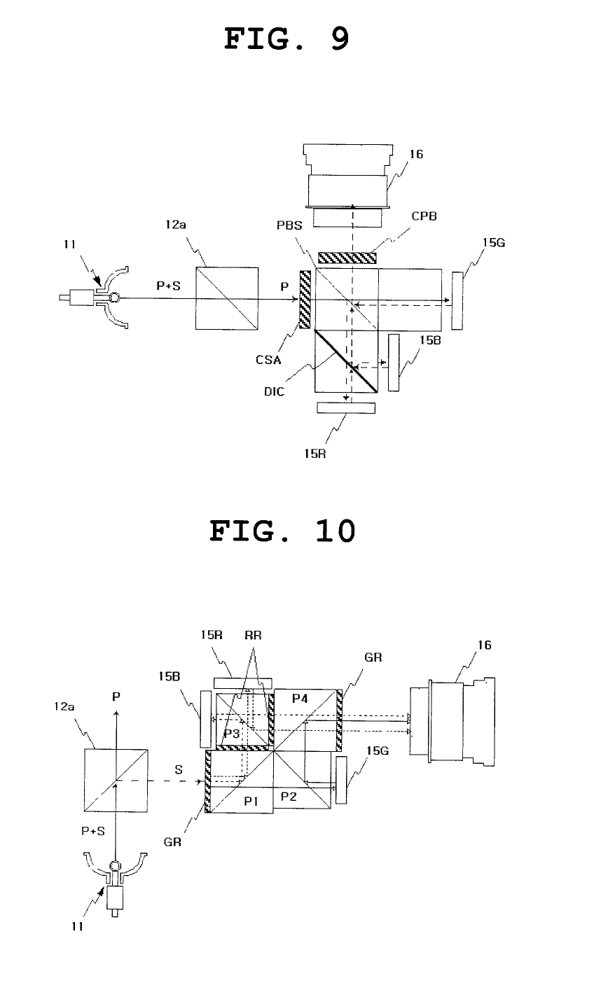

The embodiment shown in FIG. 7 to FIG. 9 uses the “color corner” to construct the color separation/composition system of the projection system, in which S-polarized light is used in FIG. 7 and FIG. 8 and P-polarized light is used in FIG. 9. Considering the structure of the color corner in referring to FIG. 7, the reference numeral 11 designates a lamp for irradiating non-polarized white light, 12a designates first polarizing beam splitter for transmitting the P wave from the light from the lamp 11 and reflecting the S wave to change the proceeding direction, 16 designates a projective system for reflecting the light including an image to a screen to form a picture image, CS1 designates first color selective polarizing plate for transmitting the S-polarized light irradiated from the first polarizing beam splitter while only polarizing green component to the P wave, PBS designates a polarizing beam splitter for transmitting the green component which is polarized to the P wave from the incident light transmitted by the first color selective polarizing plate CS1 and reflecting other components to change the proceeding direction, DIC designates a dichroic filter for separating the light reflected from the polarizing beam splitter PBS into blue and red components, 15R, 15G and 15B designate reflective LCDs for providing images corresponding to the green component of the P wave transmitted by the polarizing beam splitter PBS and the blue and red components separated in the dichroic filter DIC, CS2 designates second color selective polarizing plate for polarizing the green component of light while transmitting other components of light as they are in order to maintain the polarization state of the composed light proceeding to the projective system since the blue and red components of light are the P wave and the green component of light is the S wave as the component of the polarizing wave is varied when each of the separated RGB components of light is reflected from each of the reflective LCDs 15R, 15G and 15B as including each image.

Here, the color separation/composition system which is commonly called color corner is an association of the components designated by the reference numerals 15R, 15G, 15B, PBS, DIC, CS1 and CS2 and same as a conventional color corner.

Therefore, also the embodiment of the invention shown in FIG. 7 is means for extracting only the S wave from the light irradiated from the lamp 11 which adopts the polarizing beam splitter designated by the reference numeral 12a in using a conventional polarizing plate.

Also as shown in FIG. 8, when the S wave is extracted by commonly using the polarizing beam splitter, a certain degree of the P wave is mixed therewith. Therefore, means for extracting only the S wave again should be insured. For the purpose of this, the 3-polarizing beam splitter 12b is applied so that the volume can be reduced compared to installing the common polarizing beam splitter.

Also, FIG. 9 shows a structural view of the embodiment for illustrating the color separation/composition system where the P wave is used as a polarized component of light instead of the S wave. Then, the quality enhancement can be made through a simple structure since the transmitted P wave is hardly mixed with the S wave according to the properties of the polarizing beam splitter.

Also, the color selective polarizing plates, which were designated by the reference numerals of CP1 and CP2 in FIG. 7 and FIG. 8, are designated by CPA and CPB in FIG. 9 since the color selective polarizing plates CPA and CPB select different components of light from those selected in FIG. 7 and FIG. 8. In other words, the color selective polarizing plates CPA and CPB as shown in FIG. 9 convert the blue and red components of light with the angle of 90° into other components of polarized light.

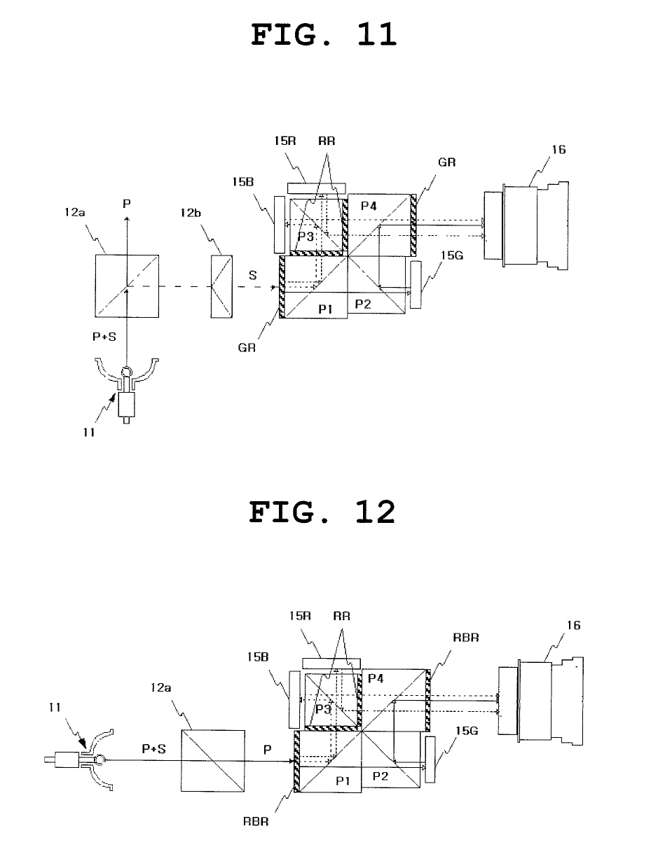

FIG. 10 to FIG. 12 show another embodiment for constructing a color separation/composition system of a projection system using a color quad, in which S-polarized light is used in FIG. 10 and FIG. 11 and P-polarized light is used in FIG. 12.

Briefly describing the structure and operation of the color quad in reference to FIG. 10, a polarizing beam splitter designated by the reference numeral of 12a is used as a polarizing element for extracting only the S wave from light from a lamp 11. The S wave from the polarizing beam splitter 12a is converted with only the green component into the P wave in a green retarder designated by the reference numeral of GR and then proceeds toward a component designated by the reference numeral P1 of 4 polarizing beam splitters composing the color quad.

Here, the green component of light is transmitted through the polarizing beam splitter P1 and the rest blue and red components of light are reflected and separated. Also, the blue and red component of light reflected from the polarizing beam splitter P1 are converted only with the red component to the P wave in a retarder RR and then proceeds toward a polarizing beam splitter P2 of said 4 polarizing beam splitters.

Therefore, each of RGB components of light has its own path. In the description hereinafter, the reference numerals replace said 4 polarizing beam splitters composing the color quad. First, considering the path of the green component of light, the green component upon being transmitted by P1 is also transmitted by P2 to be incident upon a reflective LCD designated by the reference numeral of 15G, and then is reflected and converted into the S wave as including an image. Then, the green component is reflected from P2 to proceed toward P4, and then also reflected from P4 to proceed toward a projective system 16. Here, as proceeding from P4 toward the projective system 16, the green component is converted into the P wave as passing through a green retarder designated by the reference numeral of GR to conform the polarizing condition with other components of light.

Also, describing the proceeding path of the red component of light, the red component reflected from P1 is converted into the P wave as passing through a red retarder RR, and also transmitted by P3 and incident upon a reflective LCD designated by the reference numeral of 15R to be reflected and converted into the S wave as including an image. Therefore, since a red retarder RR is present again between P3 and P4 as the red component is reflected from P3 to proceed toward P4, the red component which was converted into the S wave as reflected from the reflective LCD 15R is converted into the P wave again and thus is transmitted by P4 to proceed toward the projective system 16.

Finally, the blue component of light as the S wave reflected from Pi is reflected from P3, and is incident upon a reflective LCD designated by the reference numeral of 15B to be reflected and converted into the P wave as including an image. Therefore, the blue component having no relation with the retarders is transmitted by P3 and P4 to proceed toward the projective system 16.

Therefore, the R, G and B components of the P wave are incident upon the projective system 16.

Therefore, the embodiment of the invention as shown in FIG. 10 also uses the polarizing beam splitter 12a as means for extracting only the S wave from light irradiated from the lamp 11 instead of the polarizing plate of the prior art.

Also, as shown in FIG. 11, when the S wave is extracted by commonly using the polarizingbeam splitter, a certain degree of the P wave is mixed therewith. Therefore, means for extracting only the S wave again should be insured. For the purpose of this, a 3-polarizing beam splitter 12b is applied so that the volume can be reduced compared to installing the common polarizing beam splitter.

Also, FIG. 12 shows a structural view of the embodiment for illustrating the color separation/composition system where the P wave is used as a polarized component of light instead of the S wave. Then, the quality enhancement can be made through a simple structure since the transmitted P wave is hardly mixed with the S wave according to the properties of the polarizing beam splitter.

Also, the retarders designated by the reference numerals of GR in FIG. 10 and FIG. 11 are designated by RBR in FIG. 12 since different light component is selected in FIG. 12 different from that in FIG. 10 and FIG. 11. In other words, the red and blue retarders RBR as shown in FIG. 12 convert the blue and red components of light with the angle of 90° into other component of polarized light.

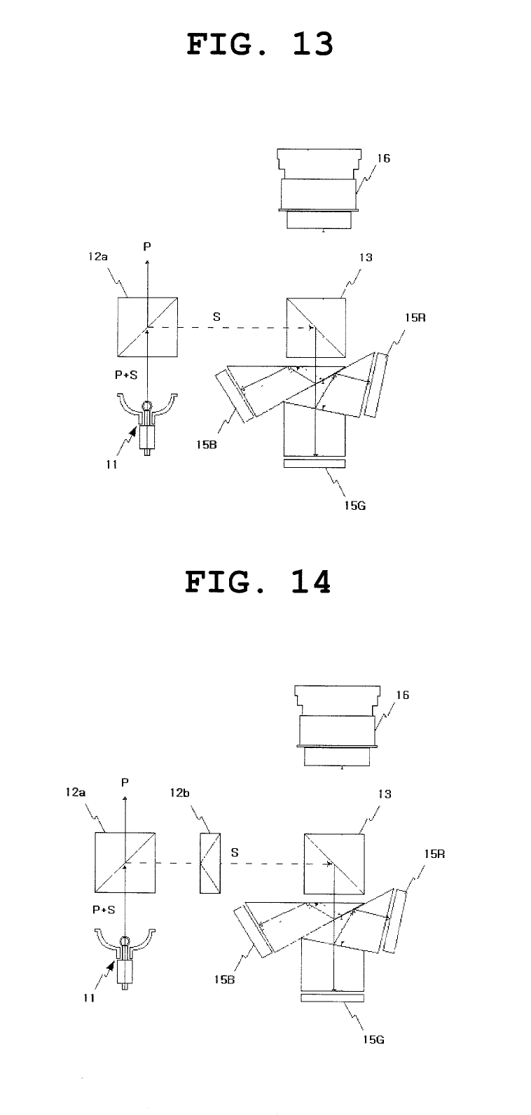

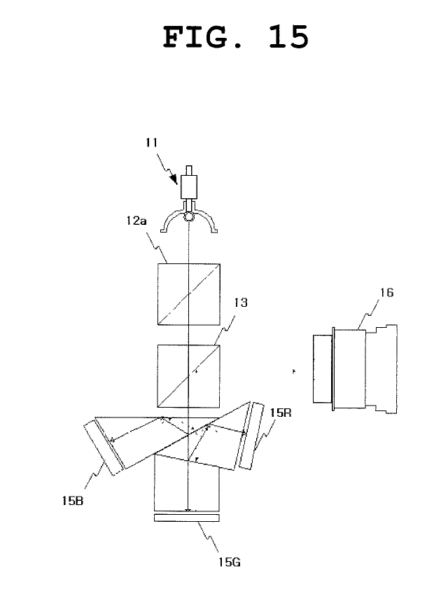

FIG. 13 to FIG. 15 show other embodiment for constructing a color separation/composition system of a projection system using a Philips prism, in which S-polarized light is used in FIG. 13 and FIG. 14 and P-polarized light is used in FIG. 15.

Briefly describing the structure and operation of the Philips prism in reference to FIG. 13, the light of S wave from a polarizing beam splitter, designated by the reference numeral of 12a and used as a polarizing element for extracting only the S wave from light from a lamp 11, is reflected at a polarizing beam splitter 13. Here, it is provided with a prism assembly (not designated by the reference numeral) which sequentially separates the S wave reflected from a polarizing beam splitter 13 into red, green and blue components of light for example and directs each of the color components to each of reflective LCDs 15R, 15G and 15B.

The prism assembly comprises three prisms arranged into a certain angle to provide two color separation faces which are dichroic coated to perform a desired color separation.

General operations of the foregoing structure is substantially same as those in the former embodiments described hereinbefore and thus the detailed description thereof will be omitted.

As described hereinbefore according to the projection system using the polarizing beam splitter of the invention, degradation of the polarizing plate during illuminating polarized light can be eliminated by using the polarizing beam splitter so that performance deterioration of the projection system can be prevented and life time of the product can be prolonged.

Also, an additional polarizing beam splitter can be arranged between the first polarizing beam splitter and the second polarizing beam splitter to function as the cleanup polarizing plate so that the polarity of illumination degraded by the reflected P wave can be enhanced.

Also, when the 3-polarizing beam splitter is used as the cleanup polarizing beam splitter, the size of the projection system can be reduced.

What is claimed is:

1. A projection system using polarizing beam splitters, said system comprising:
a lamp for irradiating non-polarized white light;
first polarizing beam splitter for transmitting unnecessary P wave from the white light irradiated from said lamp and reflecting the S wave along first direction perpendicular to the direction of the P wave;
second polarizing beam splitter for reflecting the S wave reflected from said first polarizing beam splitter along second direction perpendicular to the first incident direction and transmitting the P wave;
a color separation/composition system for separating and projecting each of R, G and B components from the S wave light reflected from said second polarizing beam splitter, and for composing the P wave light introduced along the projection direction to be projected to said second polarizing beam splitter side;
LCDs for providing an image corresponding to each of the R, G and B components of the light separated and projected from said color separation/composition system; and
a projective system for projecting the P wave light transmitted from said second polarizing beam splitter to a screen to form a picture image after each of the R, G and B components reflected from said LCDs and including each of the images is composed in said color separation/composition system.

2. A projection system using polarizing beam splitters according to claim 1, further comprising third polarizing beam splitter arranged on the light course proceeding from said first polarizing beam splitter to said second polarizing beam splitter for raising the polarity of the illumination lowered by the P wave included in the light reflected from said polarizing beam splitter and functioning as a cleanup polarizing beam splitter.

3. A projection system using polarizing beam splitters according to claim 2, wherein said cleanup polarizing beam splitter uses a 3-piece polarizing beam splitter to reduce the size of the projection system.

4. A projection system using polarizing beam splitters according to claim 1, wherein said color separation/composition system uses an X-prism.

5. A projection system using polarizing beam splitters according to claim 1, wherein said color separation/composition system uses a Philips prism.

6. A projection system using polarizing beam splitters, said system comprising:
a lamp for irradiating non-polarized white light;
a polarizing beam splitter for transmitting unnecessary 0P wave from the white light irradiated from said lamp and reflecting the S wave along first direction perpendicular to the direction of the P wave;
a color separation/composition system for separating and projecting each of R, G and B components from the S wave light reflected from said second polarizing beam splitter, and for composing the P wave light introduced along the projection direction to be projected to said second polarizing beam splitter side;
LCDs for providing an image corresponding to each of the R, G and B components of the light separated and projected from said color separation/composition system;
a projective system for projecting the P wave light transmitted from said second polarizing beam splitter to a screen to form a picture image after each of the R, G and B components reflected from said LCDs and including each of the images is composed in said color separation/composition system.

7. A projection system using polarizing beam splitters according to claim 6, further comprising third polarizing beam splitter arranged on the light course proceeding from said first polarizing beam splitter to said second polarizing beam splitter for raising the polarity of the illumination lowered by the P wave included in the light reflected from said polarizing beam splitter and functioning as a cleanup polarizing beam splitter.

8. A projection system using polarizing beam splitters according to claim 7, wherein said cleanup polarizing beam splitter uses a 3-piece polarizing beam splitter to reduce the size of the projection system.

9. A projection system using polarizing beam splitters according to claim 6, wherein said color separation/composition system uses a color corner.

10. A projection system using polarizing beam splitters according to claim 6, wherein said color separation/composition system uses a color quad.

11. A projection system using polarizing beam splitters, said system comprising:
a lamp for irradiating non-polarized white light;
first polarizing beam splitter for reflecting unnecessary S wave from the white light irradiated from said lamp and transmitting the P wave;
second polarizing beam splitter for transmitting the P wave reflected from said first polarized beam splitter and reflecting the S wave incident along the transmission direction of the P wave;
a color separation/composition system for separating and projecting each of R, G and B components from the P wave light reflected from said second polarizing beam splitter, and for composing the S wave light introduced along the projection direction to be projected to said second polarizing beam splitter side;
LCDs for providing an image corresponding to each of the R, G and B components of the light separated and projected from said color separation/composition system; and
a projective system for projecting the S wave light reflected from said second polarizing beam splitter to a screen to form a picture image, after each of the R, G and B components reflected from said LCDs and including each of the images is composed in said color separation/composition system.

12. A projection system using polarizing beam splitters according to claim 11, wherein said color separation/composition system uses an X-prism.

13. A projection system using polarizing beam splitters according to claim 11, wherein said color separation/composition system uses a Philips prism.

14. A projection system using polarizing beam splitters, said system comprising:
a lamp for irradiating non-polarized white light;
a polarizing beam splitter for reflecting unnecessary S wave from the white light irradiated from said lamp and transmitting the P wave;
a color separation/composition system for separating and projecting each of R, G and B components from the P wave light reflected from said second polarizing beam splitter, and for composing the S wave light introduced along the projection direction to be projected to said second polarizing beam splitter side;
LCDs for providing an image corresponding to each of the R, G and B components of the light separated and projected from said color separation/composition system; and
a projective system for projecting the S wave light reflected from said second polarizing beam splitter to a screen to form a picture image, after each of the R, G and B components reflected from said LCDs and including each of the images is composed in said color separation/composition system.

15. A projection system using polarizing beam splitters according to claim 14, wherein said color separation/composition system uses a color corner.

16. A projection system using polarizing beam splitters according to claim 14, wherein said color separation/composition system uses a color quad.
